(19) United States
(12) Patent Application Publication
(10) Pub. No.: US 2007/0201966 A1
(43) Pub. Date: Aug. 30, 2007

(54) FLAT HEAD SCREW

(75) Inventor: Martin S.H. Wu, Qianzhen (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: M & W FASTENER CO., LTD., Qianzhen (TW)

(21) Appl. No.: 11/307,832

(22) Filed: Feb. 24, 2006

(51) Int. Cl. F16B 23/00

(52) U.S. Cl. 411/403

(57) ABSTRACT

A flat head screw includes a flat head and a shank with threads. The flat head is integral with a coupling end of the shank and includes a top face and a bottom face. A socket is defined in the top face and extends through the bottom face into the coupling end. The coupling end includes an enlarged coupling section having a top end contiguous to the bottom face. The enlarged coupling section further includes a lower end with a tapered section. The threads extend to the enlarged coupling section. A minor diameter of the threads on the enlarged coupling section is greater than that of the threads on the remaining portion of the shank by about 5-25%. A length of the enlarged coupling section is greater than at least one pitch of the threads for forming at least one thread on the enlarged coupling section.

### BACKGROUND OF THE INVENTION

1. Field of the Invention

The present invention relates to a flat head screw. More particularly, the present invention relates to a flat head screw for fastening two thin plates together.

2. Description of the Related Art

Due to low cost and light weight, use of thin metal plates is a trend in various industries including the automobile industry, household electric appliance industry, architecture industry, etc. However, the coupling strength between the thin metal plates and the screw for fastening the thin metal plates decreases, as the coupling area between a circumferential wall delimiting each thin metal plate and the screws is reduced.

Flat head screws are used in household electric appliance and architecture to avoid adverse affect to the appearance of the appliance and the architecture. FIG. 1 of the drawings illustrates a conventional flat head screw 1 for fastening thin metal plates such as thin iron or steel plates. The flat head screw 1 has a threaded shank 13 and a flat head 11 having a socket 12 in a top face thereof. The flat head 11 is often made as thin as possible. Hence, the socket 12 must have a sufficient depth to provide sufficient coupling area with a tool for the purposes of transmitting torque from the tool to the screw 1. The depth of the socket 12 extends into an upper end of the shank 131 such that the inner end 121 of the socket 12 is very close to the minor diameter of the threads 14 adjacent to a bottom face of the flat head 11. Hence, the screw 1 is liable to break at the circled portion 15 below the flat head 1 during tightening. At the worst, the whole flat head 1 is completely broken and falls after tightening.

FIG. 2 illustrates another conventional flat head screw 2 for avoiding the problems encountered by the flat head screw 1 in FIG. 1. The flat head screw 2 includes a flat head 21, a threaded shank 23, and a truncated cone section 25 between the flat head 21 and the shank 23. A socket 22 is defined in a top face of the flat head 21. The truncated cone section 25 avoids the inner end 221 of the socket 22 to be too close to the minor diameter of the threads 24 on the shank 23. However, the threads 24 could not be formed on the truncated cone section 25 below the flat head 21 such that the bottom face 26 of the flat head 21 could not be in tight contact with the metal plate.

FIG. 3 illustrates a further conventional flat head screw 3 for avoiding the problems encountered by the flat head screw 1 in FIG. 1. The flat head screw 3 includes a flat head 31, a threaded shank 33, and a thread-free section 35 between the flat head 31 and the shank 33. A socket 32 is defined in a top face of the flat head 31. The thread-free section 35 avoids the inner end 321 of the socket 32 to be too close to the minor diameter of the threads 34 on the shank 33. However, the thread-free section 35 results in free rotation of the screw 3 when the screw 3 is tightened to the thread-free section 35, failing to provide the required tightening function.

### BRIEF SUMMARY OF THE INVENTION

A flat head screw in accordance with the present invention comprises a shank and a flat head. The shank comprises an outer circumference with threads. The shank further comprises an insertion end and a coupling end. The flat head is integral with the coupling end. The flat head comprises a top face and a bottom face. A socket is defined in the top face and extends through the bottom face into the coupling end.

The coupling end of the shank comprises an enlarged coupling section. The enlarged coupling section comprises a top end that is contiguous to the bottom face of the flat head. The enlarged coupling section further comprises a lower end with a tapered section. The threads extend to the enlarged coupling section. A minor diameter of the threads on the enlarged coupling section is greater than that of the threads on the remaining portion of the shank by about 5-25%. A length of the enlarged coupling section is greater than at least one pitch of the threads for forming at least one thread on the enlarged coupling section.

Preferably, a major diameter of the threads on the enlarged coupling section is greater than that of the threads on the remaining portion of the shank.

Preferably, the length of the enlarged coupling section is substantially equal to or slightly greater than a distance between the bottom face of the flat head and an inner end of the socket.

Preferably, the tapered section tapers toward the insertion end of the shank.

The tapered section may be is a truncated cone.

Alternatively, the tapered section comprises a circumferential concave surface.

Other objectives, advantages, and novel features of the invention will become more apparent from the following detailed description when taken in conjunction with the accompanying drawings.

### BRIEF DESCRIPTION OF THE DRAWINGS

FIG. 1 is an elevational view of a conventional flat head screw.

FIG. 2 is an elevational view of another conventional flat head screw.

FIG. 3 is an elevational view of a further conventional flat head screw.

FIG. 4 is an elevational view of an example of a flat head screw in accordance with the present invention.

FIG. 5 is an elevational view of a blank for the flat head screw in accordance with the present invention.

FIG. 6 is a schematic view illustrating the flat head screw in accordance with the present invention and two thin plates to be fastened by the flat head screw.

FIG. 7 is a view similar to FIG. 6, wherein an enlarged coupling section of the flat head screw is passing through the thin plates.

FIG. 8 is a view similar to FIG. 7, wherein the thin plates are securely fastened together.

FIG. 9 is an elevational view of another example of the flat head screw in accordance with the present invention.

FIG. 10 is an elevational view of a further example of the flat head screw in accordance with the present invention.

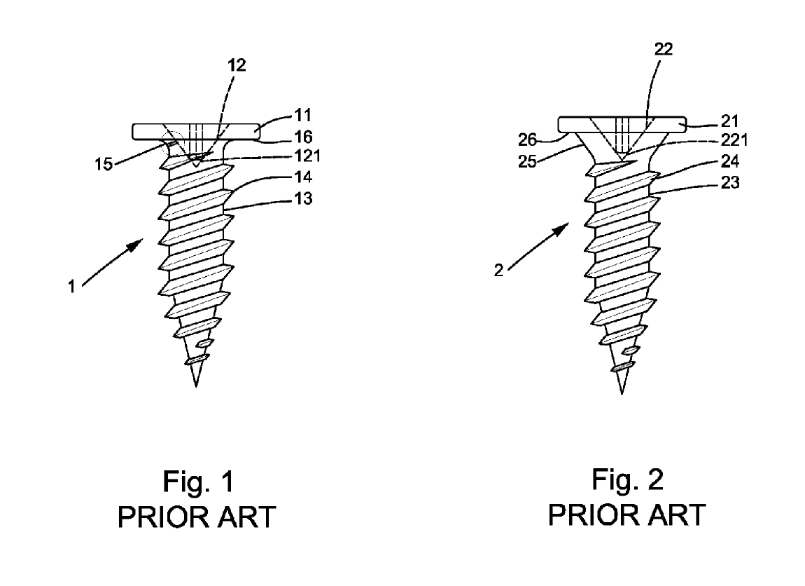

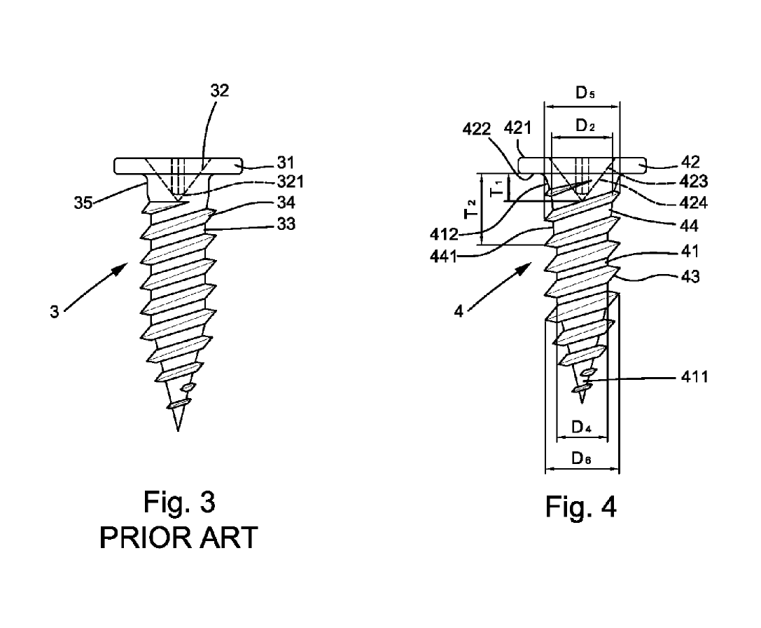

### DETAILED DESCRIPTION OF THE INVENTION

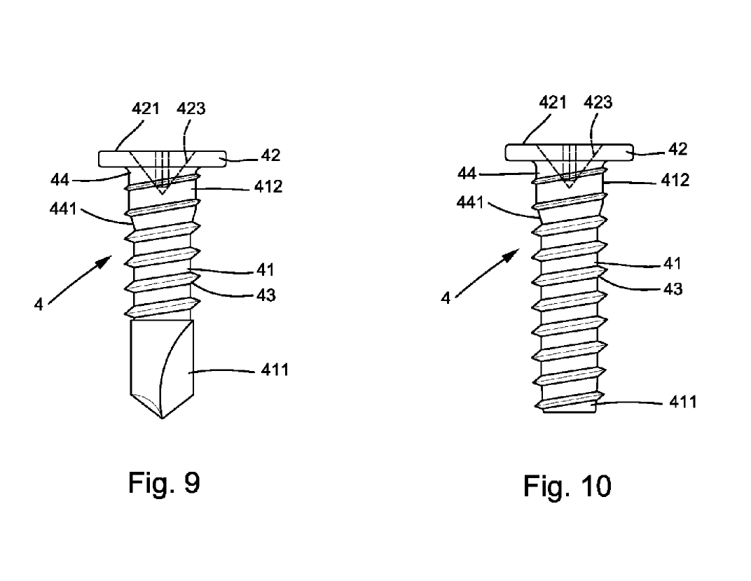

FIG. 4 illustrates an example of a flat head screw 4 in accordance with the present invention. The flat head screw 4 comprises a shank 41 and a flat head 42 on an end of the shank 41. The shank 41 comprises an insertion end 411 for penetrating thin plates or the like. The shank 41 further comprises a coupling end 412 for fastening the metal plates together. In this example, the insertion end 411 has a pointed end. In another example, the insertion end 411 may be of drill bit type, as shown in FIG. 9. In a further example, the insertion end 411 may have a flat end face, as shown in FIG. 10.

Threads 43 are formed on an outer circumference of the shank 41 from the coupling end 412 through the insertion end 411. The types, pitches, or groove sizes of the threads 43 may be of any standard sizes. Namely, the threads of the flat head screw 4 in accordance with the present invention are not limited to those shown in the accompanying drawings.

The flat head 42 is integral with the coupling section 412 of the shank 41 and comprises a top face 421 and a bottom face 422. A socket 423 is defined in the top face 421 of the flat head 42 and preferably extends along a longitudinal direction of the screw 4. The socket 423 extends through the bottom face 422 of the flat head 42 into the coupling end 412 of the shank 41. A distance Ti between an inner end 424 of the socket 423 and the bottom face 422 of the flat head 42 is long enough to provide a contact area and depth sufficient for transmitting the torque from a tool (not shown) to the screw 4. The socket 423 is conic in this example. Nevertheless, the socket 423 may be cruciform, star-shaped, square, hexagonal, indented hexagonal or of any other conventional shape.

The coupling end 412 of the shank 41 comprises an enlarged coupling section 44. The enlarged coupling section 44 comprises a top end contiguous to the bottom face 422 of the flat head 42. The enlarged coupling section 44 further comprises a lower end with a tapered section 441 that tapers toward the insertion end 411. Threads 43 are also formed on the enlarged coupling section 44. A minor diameter D2 of the threads 43 on the enlarged coupling section 44 is greater than a minor diameter D4 of the threads 43 on the remaining portion of the shank 41 by about 5-25%. Further, a length T2 of the enlarged coupling section 44 is preferably substantially equal to or greater than the distance T1 between the bottom face 424 of the flat head 42 and the inner end 424 of the socket 423. Further, the length T2 of the enlarged coupling section 44 is greater than at least one pitch of the threads 43 for forming at least one thread 43 on the enlarged coupling section 44. In this example, the length T2 of the enlarged coupling section 44 allows formation of at least one thread 43 on the enlarged coupling section 44. Preferably, a major diameter D5 of the threads 43 on the enlarged coupling section 44 is greater than a major diameter D6 of the threads 43 on the remaining portion of the shank 41.

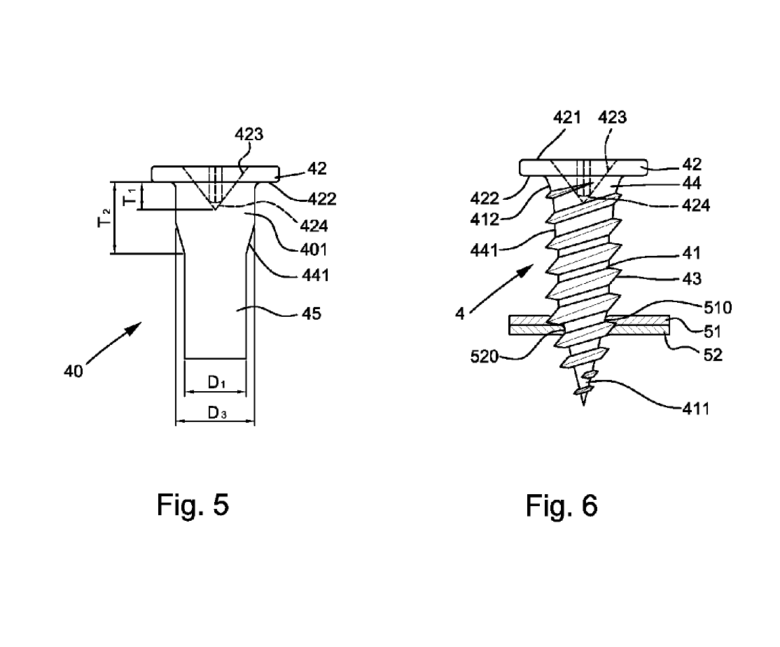

FIG. 5 shows a blank 40 for producing the screw 4, wherein the threads 43 have not formed yet. The blank 40 comprises a shank portion 45, a flat head 42, and an enlarged section 401 between the flat head 42 and the shank portion 45. An outer diameter D3 of the enlarged section 401 is greater than that D1 of the shank portion 45 by about 5-25%. A length T2 of the enlarged section 401 is preferably slightly greater than the distance Ti between a bottom face 422 of the flat head 42 and an inner end 424 of a socket 423 of the flat head 42. Hence, the enlarged section 401 encompasses the inner end 424 of the socket 423. Further, the enlarged section 401 comprises a tapered section 441 that tapers toward a distal end of the shank portion 45. After machining the blank 40 to form threads 43, a flat head screw 4 (FIG. 4) is obtained. The threads 43 can be formed on the enlarged coupling section 44 and extend to a position adjacent to the bottom face 422 of the flat head 42.

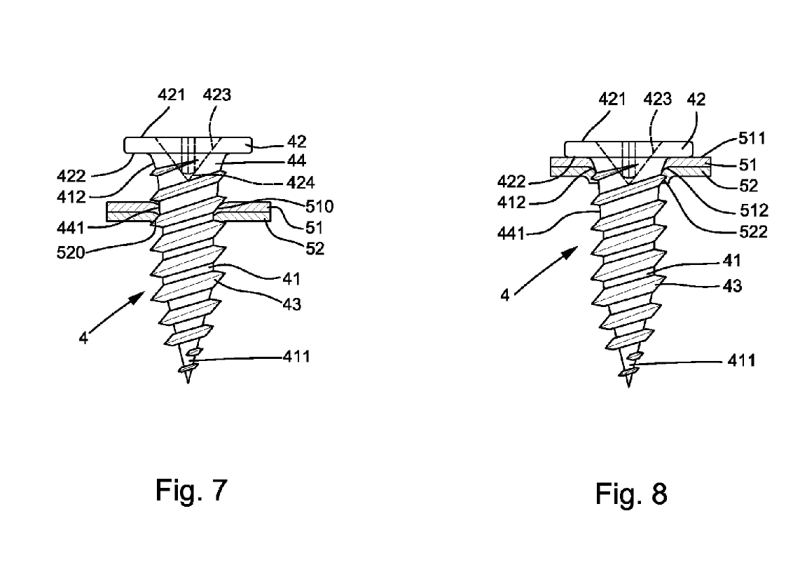

Referring to FIG. 6, when fastening two thin plates 51 and 52 made of metal, plastic, or other materials together, the screw 4 penetrates the thin plates 51 and 52 with the insertion end 411 and creates a hole 510, 520 in each thin plate 51, 52. Referring to FIG. 7, when the enlarged coupling section 44 of the screw 4 is passing through the thin plates 51 and 52, the tapered section 441 comes into contact with circumferential walls 512 and 522 delimiting the holes 510 and 520 and exerts a radially outward force to the circumferential walls 512 and 522, resulting in radially outward expansion of the circumferential walls 512 and 522.

FIG. 8 illustrates the thin plates 51 and 52 securely fastened together by the screw 4. The bottom face 422 of the flat head 42 is tightened to and in intimate contact with a top side 511 of the upper thin plate 51. The circumferential walls 512 and 522 that initially expand radially outward are squeezed toward the insertion end 411 such that the biting area between the threads 43 of the enlarged coupling section 44 and the circumferential walls 512 and 522 delimiting the holes 510 and 520 is increased as compared to the conventional flat head screws. The coupling strength provided by the flat head screw 4 in accordance with the present invention is thus relatively high.

When using a #10 flat head screw 4 (or having a major diameter of 4.8 mm) in accordance with the present invention to fasten two thin iron plates 51 and 52 each with a thickness of 0.6 mm, it was found that an unfastening torque of 45 kg in the reverse direction is required for unfastening, compared to 22 kg for conventional flat head screws.

Further, since the minor diameter D2 of the threads 43 on the enlarged coupling section 44 is greater than the minor diameter D4 of the threads 43 on the shank 41 by about 5-25%, the distance between the outer circumference of the coupling end 412 of the flat head 4 and the inner end 424 of the socket 423 is sufficiently long to avoid the flat head 42 from being broken during or after tightening.

Although the length T2 of the enlarged coupling section 44 is preferably equal to or greater than the distance Ti between the bottom face 424 of the flat head 42 and the inner end 424 of the socket 423, the length T2 could be smaller than the distance T1 as long as at least one thread 43 can be formed on the enlarged coupling section 44 within the range of the distance T1. Further, the tapered section 441 in the illustrated example is a truncated cone. In an alternative arrangement, the tapered section 441 may include a concave circumferential surface.

Although specific embodiments have been illustrated and described, numerous modifications and variations are still possible without departing from the essence of the invention. The scope of the invention is limited by the accompanying claims.

What is claimed is:

1. A flat head screw comprising:
a shank comprising an outer circumference with threads, the shank further comprising an insertion end and a coupling end; and
a flat head integral with the coupling end, the flat head comprising a top face and a bottom face, a socket being defined in the top face and extending through the bottom face into the coupling end;
the coupling end of the shank comprising an enlarged coupling section, the enlarged coupling section comprising a top end that is contiguous to the bottom face of the flat head, the enlarged coupling section further comprising a lower end with a tapered section, the threads extending to the enlarged coupling section, a minor diameter of the threads on the enlarged coupling section being greater than that of the threads on the remaining portion of the shank by about 5-25%, and a length of the enlarged coupling section being greater than at least one pitch of the threads for forming at least one thread on the enlarged coupling section.

2. The flat head screw as claimed in claim 1 wherein a major diameter of the threads on the enlarged coupling section is equal to or slightly greater than that of the threads on the remaining portion of the shank.

3. The flat head screw as claimed in claim 1 wherein the length of the enlarged coupling section is equal to or slightly greater than a distance between the bottom face of the flat head and an inner end of the socket.

4. The flat head screw as claimed in claim 1 wherein the tapered section tapers toward the insertion end of the shank.

5. The flat head screw as claimed in claim 1 wherein the tapered section is a truncated cone.

6. The flat head screw as claimed in claim 1 wherein the tapered section comprises a circumferential concave surface.
